(19) United States
(12) Patent Application Publication
(10) Pub. No.: US 2016/0185321 A1
(43) Pub. Date: Jun. 30, 2016

(54) Boat Trailer Rinse System

(71) Applicant: John Cramer, Dade City, FL (US)

(72) Inventor: John Cramer, Dade City, FL (US)

(21) Appl. No.: 14/584,627

(22) Filed: Dec. 29, 2014

(51) Int. Cl. B60S 1/66; B08B 3/02; B60P 3/10

(52) U.S. Cl. CPC B60S 1/66; B60P 3/1033; B08B 3/02

(57) ABSTRACT

An integrated liquid storage and powered liquid distribution system is secured to or integrated with a boat trailer to provide a rinse system for a boat trailer. It provides a maximum of storage volume through a novel storage tank configuration that is secured to the structure of an open-framework trailer construction. The storage tank is formed of a series of elongated cylinders that are interconnected to form a polygon. The cylinders are each sized to be located and secured to the vertical sides of individual trailer structural members, without extending substantially into the surrounding space.

### BACKGROUND

The present invention pertains to systems for rinsing of boat trailers. Particularly, the invention concerns systems mounted to or integrated with the framework of a conventional boat trailer to provide both storage and distribution devices for rinsing the trailer with a liquid cleaning agent such as water.

Many small water craft such as boats are removed from the water after use, often by use of a wheeled trailer than may be pulled behind a vehicle. Typically, both the boat and the trailed contain elements that are susceptible corrosion, for example water-cooled engines and trailer wheel components. This is particularly true where the boat and trailer use is in salt water. For this reason, it is common to wash or rinse both the boat and trailer with clean water after use. Unfortunately, there often is no clean water source or no facilities for cleaning near the location where trailers are pulled from the body of water where the boat had been operated.

Various systems have been developed in the past for rinsing trailers in just situations. Systems are known that include water storage tanks secured to a trailer and connected to rinse spraying devices. These suffer from various weaknesses including a lack of sufficient water storage. Various reasons exist for this lack including the spatial limitations of the trailer. That is, for example, structures—such as rinse system components—on the trailer must not interfere with the loading and unloading operations with the boat. Furthermore, road clearance and perimeter clearance must be maintained for normal operation of the trailer. These restrictions make difficult securing or adding sufficient storage volume. What is needed is a trailer mounted rinse system that provides sufficient water volume storage and is easy to use.

### SUMMARY OF THE INVENTION

The present invention provides an integrated liquid storage and powered distribution system that may be secured to or integrated with a boat trailer. It provides a maximum of storage volume through a novel storage tank configuration that is secured to the structure of an open-framework trailer construction. The storage tank is formed of a series of elongated cylinders that are interconnected to form a polygon. The cylinders are each sized, both in diameter and length, to be located and secured to the vertical sides of individual trailer structural members, without extending substantially into the surrounding space.

The inventive storage tank is not pressurized but provides a rinse liquid source to a powered distribution rinse pump. The pump may be connected to any of a variety of rinse devices for distributing a rinse liquid to the trailer, a boat carried on the trailer, or other surrounding articles. The pump is preferably electrically connected to and powered by a vehicle secured to the trailer for travel purposes.

The invention includes an improved boat trailing incorporating the inventive rinse tank and distribution system. Other novel aspects of the invention will be explained through the following detailed discussion and accompanying figures.

### DESCRIPTION OF THE DRAWINGS

FIG. 1 is a perspective illustration of one embodiment of the invention incorporated into a conventional boat trailer.

FIG. 2 is a perspective schematic illustration of the supply and distribution elements of one configuration of a rinse system according to the invention.

### DETAILS OF EMBODIMENTS OF THE INVENTION

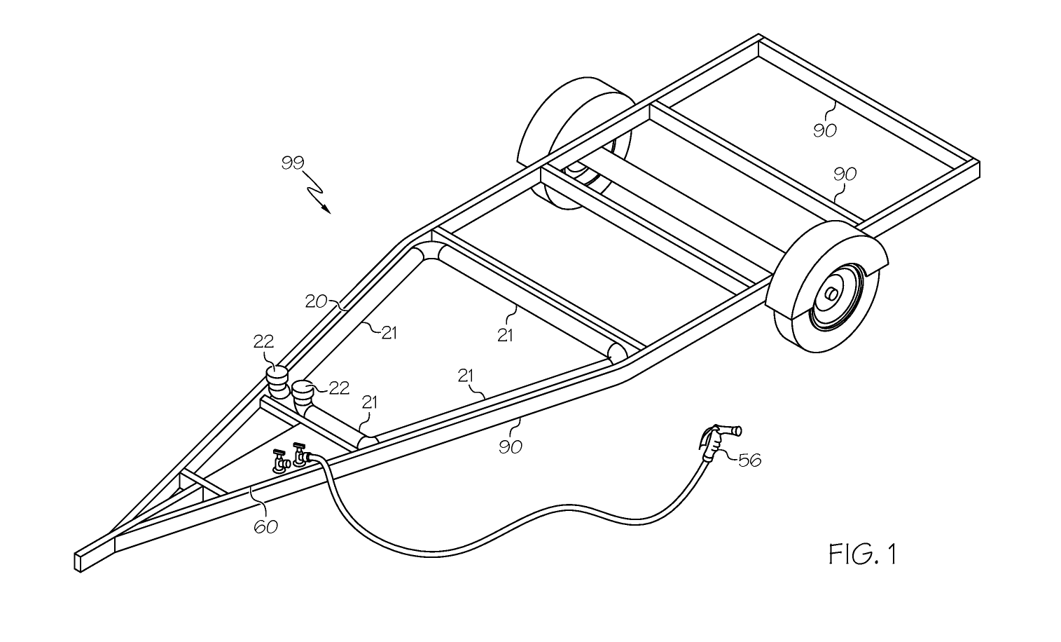

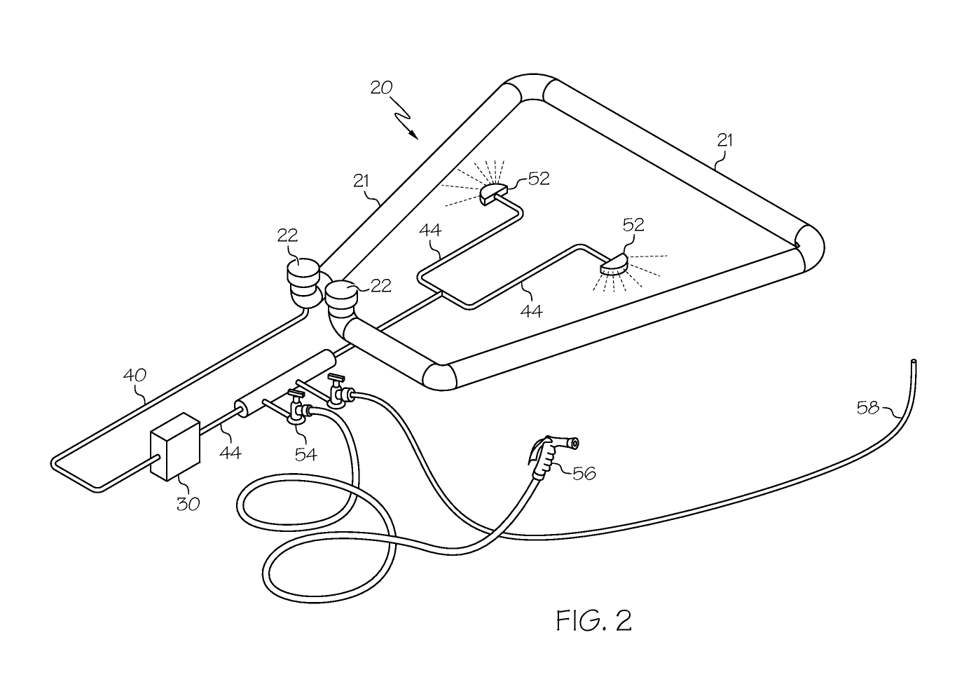

FIG. 1 illustrates one embodiment of the invention. A conventional boat trailer 99 is formed of an open framework of rigid beams 90. The trailer wheels and suspension are supported from the beams 90 and any of a variety of boat-supporting elements may be included (not shown for clarity). The manner of support of the boat on the trailer 99 and the manner of trailer use is not critical to the invention and the inventive system may be incorporated on any similarly constructed trailer having a similar open framework form. FIG. 2 is a schematic illustration of elements involved in water storage and distribution of the system. Some of the elements illustrated in FIG. 2 are not shown in FIG. 1 for clarity, however their relationship and interaction with the structures of the trailer 99 will be made clear in the discussion below.

Liquid (water or other appropriate liquid) storage for the rinse system is provided by a series of interconnected elongated hollow containers that are sized and oriented to fit in a nested manner within the open framework of the trailer 99. This nested configuration is critical to minimize the spacial interference of the rinse system on the conventional and typical boat and trailer operations. As shown in FIG. 1, a storage tank 20 is formed of multiple elongated storage cylinders 21. Each cylinder 21 is located adjacent and parallel to the inside face of a respective trailer beam 90. For reference, the trailer frame and the beams 90 are generally horizontal in normal condition of retaining a boat; and in that attitude, the cylinders are each horizontal as well. Each cylinder 21 extends, preferably fully, between adjacent beam junctions to maximize length and volume, while allowing space for connecting elements to the adjacent cylinder. Adjacent cylinders 21 are cojoined to allow their cavities to communicate such as to form a contiguous storage volume. Preferably, the cylinders 21 are arranged and connected in the general form of a polygon, with one end of a first cylinder adjacent to the that of the last cylinder in the series. A closed polygon configuration, with a single opening, is an alternative configuration. As shown in the figure, these two cylinder ends are upturned and capped with easy-to-remove caps 22 to facilitate filling. While the word “cylinder” is used to identify the individual storage container elements of the tank 20, these elements may have non-cylindrical shape. While the illustrated configuration includes four cylinders 21 as containers making up the tank 20, other configuration using fewer or more containers similarly employed and interconnected may function in similar manner and satisfy the requirements of the invention. In any alternative configuration, the cylinders 21 should be closely coupled to at least one trailer beam element or connected rigid structure and each cylinder 21 should be sized similarly to avoid spacial interference. It should be clear that cylinders mounted with a vertical long axis should not satisfy these requirements.

The cylinders 21 and other elements of the storage tank 20 should be rigidly secured to the trailer beams 90 or other structure of the the trailer 99. Conventional rigid brackets such as “U” bolts similar devices may be used. These elements are conventional and are not illustrated in the figures for clarity.

Most preferably, for ease of construction, the cylinders 21 are formed of conventional rigid PVC (polyvinyl chloride) pipe sections, interconnected by corresponding fittings. The diameter of the cylinders 21 should be at least as large as the transverse dimension (vertical height in the figure) of the beams 90 to maximize volume and may be as large as four (4) inches in diameter for typical small boat trailers. Larger diameters may result in interference with trailer required clearance zones or with the associated boat spatial envelope. However, where larger section trailer frame beams are used, the cylinder diameter or size may be correspondingly larger. The important aspect being that the cylinders do not substantially extend above or below the trailer beams. Other materials and devices may be used to form and connect the cylinders 21, including metals and other non-metallic materials.

A conventional typical small boat trailer may have an open section of beams as shown with side beam lengths of 72 inches and crossing beam lengths of 72 inches and 72 inches, respectively. With a cylinder diameter of four inches, a storage volume of about 10 gallons is enabled. This volume is sufficient for effective rinsing of the corresponding boat and trail under typical conditions.

In the present rinse system, the cylinders 21 are not pressurized and the distribution system doe not rely on storage pressurization to transport and distribute the rinsing media. For this reason, the configuration of the storage tank 20 need not satisfy the requirements of typical pressure vessels such as pressurizing tanks. It is important that the cylinders and storage tank 20 not be pressurized, as the illustrated and suggested configuration, if pressurized, would be more susceptible to failure than are conventional pressure vessels.

Distribution of the rinse water from the storage tank 20 is accomplished by an external pump 30 that is mounted to the trailer 99. Supply piping 40 is connected to a low point of the storage tank 20 and may include an internal suction hose positioned within one or more portions of the tank 20. The supply piping 40 extends from the storage tank 20 to the inlet of the pump 30. The pump 30 is shown schematically in FIG. 2 and may take the form of any of a variety of conventional powered pumps. Preferably, the pump 30 is electrically powered and preferably includes conventional electrical connections (not illustrated) enabling connection to a trailer-associated vehicle and its 12 volt electrical power system. It is suggested that the pump 30 is selected to provide water volume in the range of one to ten gallons per minute at a pump outlet total pressure of 10 PSI (pounds per inch) although this is not limiting and any desired and effective volume rate and pressure may be used.

From the pump 30, pumped rinse water may be distributed to any of a number of different devices and methods for rinse operations. FIG. 2 illustrates an example distribution piping 44 that connects the pump 30 to spray heads 52, hose valve 54 with attached hose and manually operated spray outlet 56. The spray heads 52 maybe secured to the trailer 99 members and directed at particular trailer components, such as the inside faces of the trailer wheels. Another, optional, convenient distribution device illustrated is an engine rinse line with engine connection 58, for providing internal flushing to an gasoline powered outboard motor or the like. Other rinse distribution line configurations and rinse devices may be incorporated in conventional fashion.

As shown in FIG. 1, the pump 30 and valve elements are most conveniently included within a pump housing 60 secured to or integrated with the trailer 99, although this is not limiting.

In use, the storage tank 20 is filled, preferably through the open end of the tank after removal of a cap 22. As needed, the pump 30 is operated to draw water from the tank 30 and pump it to one or more distribution devices. A conventional vent may be included on the tank 30 to enable makeup air to enter during pumping. In the above, while the rinse media is referred to as “water”, any appropriate liquid cleaning agent may be similarly used and any such should be considered “water” for the purposes herein.

Other configurations of the inventive aspects detailed above are contemplated and will be obvious to one skilled in the art. The scope of the invention is intended to be defined by the following claims.

1. A rinsing system for securing to and rinsing of a boat trailer formed of an open frame of structure members, the rinsing system comprising:
multiple elongated storage containers, all interconnected to allow communication and flow of contained liquid throughout;
the multiple containers configured to enable each container to be independently secured to a respective trailer frame member such that the multiple containers form a polygon arrangement;
a pump configured to receive liquid from the multiple containers;
a least one distribution device configured to received liquid from the pump and distribute the liquid to elements of the trailer.

2. A rinsing system, according to claim 1, and wherein:
the multiple elongated containers comprise three cylinders.

3. A boat trailer comprising:
a trailer frame comprising multiple open frame members;
multiple elongated storage containers, all containers interconnected to allow communication and flow of contained liquid throughout;
each container secured to a respective trailer frame member;
a pump secured to the trailer frame and configured to receive liquid from the multiple containers; and
a least one distribution device configured to received liquid from the pump and distribute the liquid to the trailer frame.

4. A boat trailer, according to claim 3, and wherein:
each container does not extend vertically beyond its secured frame member.

5. A boat trailer, according to claim 4, and wherein:
the multiple containers comprises four containers.

6. An improved boat trailer having an open frame of beam members, wherein the improvement comprises:
multiple elongated containers each secured parallel to a respective beam member, the containers interconnected to form an single storage tank;
a liquid distribution system connected to the storage tank;
such as to enable liquid stored in the tank to be distributed to the trailer.
